(19) United States
(12) Patent Application Publication
(10) Pub. No.: US 2006/0247025 A1
(43) Pub. Date: Nov. 2, 2006

(54) Gaming machine

(75) Inventors: Kazunobu Sato, Tokyo (JP); Shinji Hara, Tokyo (JP)

Correspondence Address: ARENT FOX PLLC, 1050 CONNECTICUT AVENUE, N.W., SUITE 400, WASHINGTON, DC, 20036, US

(73) Assignee: ARUZE CORP.

(21) Appl. No.: 11/411,941

(22) Filed: Apr. 27, 2006

(30) Foreign Application Priority Data
Apr. 28, 2005 (JP) 2005-132410
Apr. 28, 2005 (JP) 2005-132429

(51) Int. Cl. A63F 13/00

(52) U.S. Cl. 463/25; 463/20

(57) ABSTRACT

In the slot machine 1, when the payout correspondence table 33a of the RAM 33 is changed to the special payout correspondence table 33b, the special payout information 4C, 4D on the basis of the special payout correspondence table 33b is displayed on the sub-display 4, instead of the payout information 4A, 4B on the basis of payout correspondence table 33a. Therefore, till the special payout information 4C, 4D is displayed on the sub-display 4, the player cannot confirm the special payout information 4C, 4D, thus the player cannot predict the payout. As a result, for the player, unexpected feeling of the payout can be raised and interest for games can be improved.

### CROSS-REFERENCE TO THE RELATED APPLICATIONS (S)

This application is based upon and claims a priority from the prior Japanese Patent Application Nos. 2005-132410 and 2005-132429 filed on Apr. 28, 2005, respectively, the entire contents of which are incorporated herein by reference.

### BACKGROUND OF THE INVENTION

1. Field of the Invention

The present invention relates to a gaming machine in which a series of plural symbols are variably displayed.

2. Description of Related Art

Conventionally, there exists a gaming machine in which a series of plural symbols are variably displayed on each of variable display portions arranged in a display device, and if a stop mode of the symbols stopped and displayed on each of the variable display portions corresponds to a predetermined winning symbol combination, a payout with a payout number corresponding to the winning symbol combination is conducted. This kind of the gaming machine is, for example, disclosed in Unexamined Japanese Patent Publication No. 2001-120716. In the gaming machine disclosed in Unexamined Japanese Patent Publication No. 2001-120716, standard payouts are displayed on a payout display portion, and when a bet number becomes more than 2, it is determined whether or not the standard payout is changed to a special payout which has a value larger than the standard payout, thereafter change to the special payout is informed. According to this gaming machine, when a player bets with a bet number more than 2, payout increases. Therefore, the player generally considers that a further merit can be obtained by additionally betting, therefore unexpected feeling and interest can be raised for the player.

Under above situation, inventors variously investigated the gaming machine, as a result, they found a gaming machine that interest for games can be raised by making difficult for the player to predict the payout before the game is started.

Further, in most of the above gaming machines, it is provided a base game mode in which a base game is conducted and a special game mode in which a bonus game such as a free game and the like are conducted. In this kind of gaming machine is, for example, disclosed in Unexamined Japanese Patent Publication No. 2005-34301. And among these gaming machines, there exists a gaming machine in which it is provided a plurality of special game modes and the bonus games different with each other are respectively conducted in each of the special game modes.

However, in the conventional gaming machine with plural special game modes, it is conducted a control so that a shift condition to shift to the other special game modes is not realized while the game mode becomes one special game mode or a control so that the shift condition to shift to the other special game modes is invalidated. That is to say, in the above gaming machine, only any one of the shifts conditions is selectively realized or is sequentially realized among plural special game modes, thereby interest of the player for games cannot be sufficiently raised in spite that the gaming machine has plural special game modes.

### SUMMARY OF THE INVENTION

Thus, in order to dissolve the above problems, the present invention has been done and has an object to provide a gaming machine in which interest for games can be further raised.

And the present invention has a further object to provide a gaming machine with plural special game modes in which interest for a game can be further raised.

In order to accomplish the above object, according to one aspect of the present invention, it is provided a gaming machine comprising a gaming machine including a display device having a plurality of variable display portions on each of which a symbol is variably displayed, wherein when a stop mode of the symbols stopped and displayed on the variable display portions corresponds to a winning symbol combination, a payout with a payout number corresponding to the winning symbol combination is conducted,

the gaming machine further comprising:

a memory device for storing payout correspondence data in which a correlation between the winning symbol combination and the payout number is set;

a display control device for controlling the display device so as to display payout information indicating the correlation;

a symbol determination device for determining the symbols stopped and displayed on the variable display portions of the display device;

a payout process device for conducting a payout process corresponding to the payout number correlated with the winning symbol combination based on the payout correspondence data stored in the memory device, when the stop mode of the symbols determined by the symbol determination device corresponds to the winning symbol combination in the payout correspondence data; and

a data change device for changing the payout correspondence data stored in the memory device to special payout correspondence data which are more beneficial than the payout correspondence data;

wherein when the payout correspondence data are changed to the special payout correspondence data by the data change device, the display control device controls the display device so as to display special payout information based on the special payout correspondence data instead of the payout information and the payout process device conducts the payout process according to the special payout correspondence data instead of the payout correspondence data.

In the gaming machine, in a case that the stop mode of the symbols determined by the symbol determination device and stopped and displayed on the display device corresponds to the winning symbol combination in the payout correspondence data stored in the memory device, it is conducted by the payout process device the payout process with the payout number correlated with the winning symbol combination through the payout correspondence data. And when the payout correspondence data stored in the memory device are changed to the special payout correspondence data by the data change device, the special payout information on the basis of the special payout correspondence data are displayed on the display device instead of the payout information on the basis of the payout correspondence data. Therefore, the player cannot confirm the special payout information till the special payout information is displayed on the display device, thus the player cannot predict how the payout becomes. As a result, unexpected feeling of the payout is raised for the player and interest for games in the gaming machine can be improved. Further, at a voluntary timing, the special payout information can be displayed on the display device, therefore unexpected feeling of the payout can be raised.

As mentioned in the above, according to the present invention, it can be provided a gaming machine through which interest for games can be raised.

Further, according to another aspect of the present invention, it is provided a gaming machine having a base game state in which a base game is conducted, a specific game state in which a specific game is conducted, a first special game state in which a first special game is conducted and a second special game state in which a second special game is conducted,

the gaming machine further comprising:

a first shift determination device for determining whether or not a first shift condition to shift the base game state to the specific game state is realized;

a second shift determination device for determining whether or not a second shift condition to shift the base game state to the first special game state is realized;

a first shift device for shifting the base game state to the specific game state when the first shift determination device determines that the first shift condition is realized; and

a second shift device for shifting the base game state to the second special game state when the first shift determination device determines that the first shift condition is realized and the second shift determination device determines that the second shift condition is realized.

In the gaming machine mentioned in the above, there are provided the base game state in which the base game is conducted, the specific game state in which the specific game is conducted, the first special game state in which the first special game is conducted and the second special game state in which the second special game is conducted. And the game state usually becomes the base game state in which the base game is conducted, and when the first shift determination device determines that the first shift condition is realized, the base game state is shifted to the specific game state by the first shift device. Here, when the first shift determination device determines that the first shift condition is realized and the second shift determination device determines that the second shift condition is realized, the base game state is shifted to the second special game state by the second shift device. In this gaming machine, when the first shift determination device determines that the first shift condition is realized and the second shift determination device determines that the second shift condition is realized, the game is conducted in the second special game state which is different from the game conducted in the first special game state. Therefore, in comparison with the conventional gaming machine in which only any one of special games is selectively realized, interest of the player for games can be efficiently raised. And in the gaming machine, when the number of the shift condition to shift to the special game state is changed from one to two, the game state can be drastically changed, thus it can be provided the gaming machine in which unexpected feeling is raised for the player.

As mentioned in the above, according to the present invention, it can be provided a gaming machine with plural special game states, in which interest for games can be raised.

The above and further objects and novel features of the invention will more fully appear from the following detailed description when the same is read in connection with the accompanying drawings. It is to be expressly understood, however, that the drawings are for purpose of illustration only and not intended as a definition of the limits of the invention.

### BRIEF DESCRIPTION OF THE DRAWINGS

The accompanying drawings, which are incorporated in and constitute a part of this specification illustrate embodiments of the invention and, together with the description, serve to explain the objects, advantages and principles of the invention.

In the drawings,

FIG. 1 is a perspective view showing a whole construction of a slot machine as a gaming machine according to the first embodiment,

FIG. 2 is a block diagram showing an inner construction of the slot machine,

FIG. 3 is a block diagram showing one example of an inner construction of an image control circuit,

FIG. 4 is an explanatory view schematically showing a construction of a payout correspondence table stored in a RAM,

FIG. 5 is an explanatory view showing payout information displayed on a sub-display,

FIG. 6 is a flowchart showing operational procedures from a start of slot game machine game to an end thereof,

FIG. 7 is an explanatory view showing a construction of a special payout correspondence table,

FIG. 8 is an explanatory view showing special payout information,

FIG. 9 is a flowchart showing operational procedures of a bonus game process,

FIG. 10 is a flowchart showing operational procedures different from those in FIG. 6,

FIG. 11 is an explanatory view showing one example of an image displayed on a main display,

FIG. 12 is an explanatory view showing one example of a stop table,

FIG. 13 is a flowchart showing operational procedures from a start of slot game machine game to an end thereof in the second embodiment,

FIG. 14 is a flowchart showing operational procedures of a bonus game process in the second embodiment, and

FIG. 15 is a flowchart showing a changing state of game modes.

### DETAILED DESCRIPTION OF THE PREFERRED EMBODIMENTS

Hereinafter, the first embodiment of the present invention will be described. Here, the same reference number will be attached to the same element and repetitious explanation will be omitted.

(Construction Of Slot Machine)

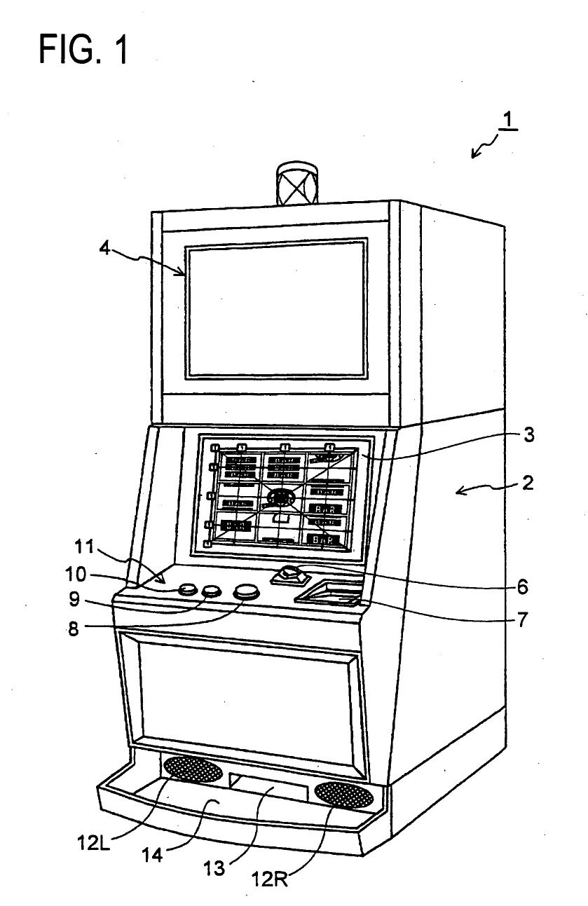

FIG. 1 is a perspective view showing a whole construction of a slot machine 1. The slot machine is a gaming machine according to the first embodiment of the present invention and is constructed so that a variable display game utilizing a plurality of symbols (called as a slot game) can be conducted. In the slot machine 1, it is provided a base game mode in which a base game unconditionally started from a game start can be conducted and a special game mode in which a bonus game started continuous to the base game under a predetermined condition can be conducted. Even in the special game mode, the variable display game can be done.

A slot machine 1 has a main display 3 with a liquid crystal display device on a front plane of a cabinet 2. And at an upper position of the main display 3, a sub-display 4 with a liquid crystal display device similar to the main display 3 is arranged. These main display 3 and the sub-display 4 constructs the display device in the present invention.

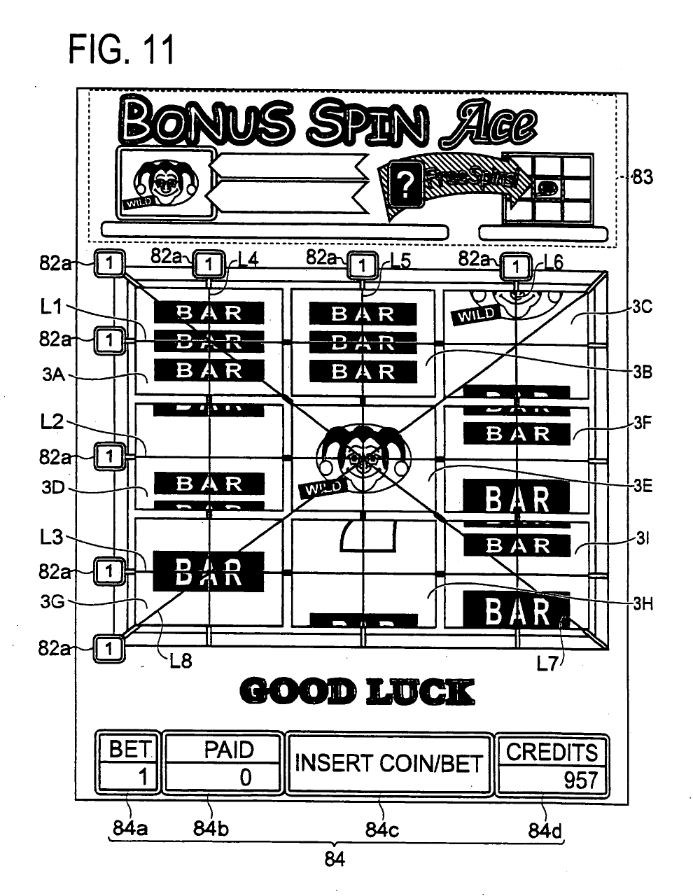

The main display 3 is constructed, as shown in FIG. 11, so that nine variable display portions 3A, 3B, 3C, 3D, 3E, 3F, 3G, 3H, 3I are arranged in a 3×3 matrix state. On the main display 3, scroll display images (reel images displayed as if mechanically reels rotate) are displayed as if plural symbols are moved from an upper position toward a lower position. Here, since the slot machine 1 has nine variable display portions 3A˜3I, eight pay lines (L1˜L8) can be totally set along vertical three lines, horizontal three lines and two diagonal lines formed by the variable display portions 3A˜3I arranged in the matrix arrangement.

On the sub-display 4, in addition to payout information and special payout information mentioned later, images not directly concerned with the game (for example, explanation of game contents and winning effects) are displayed.

And in the slot machine 1, a control table 11 which is substantially horizontally extended is formed at a lower side of the main display 3. On the control table 11, a coin insertion slot 6, a bill insertion slot 7, a spin switch 8, a 1-BET switch 9 and a maximum BET switch 10 are arranged.

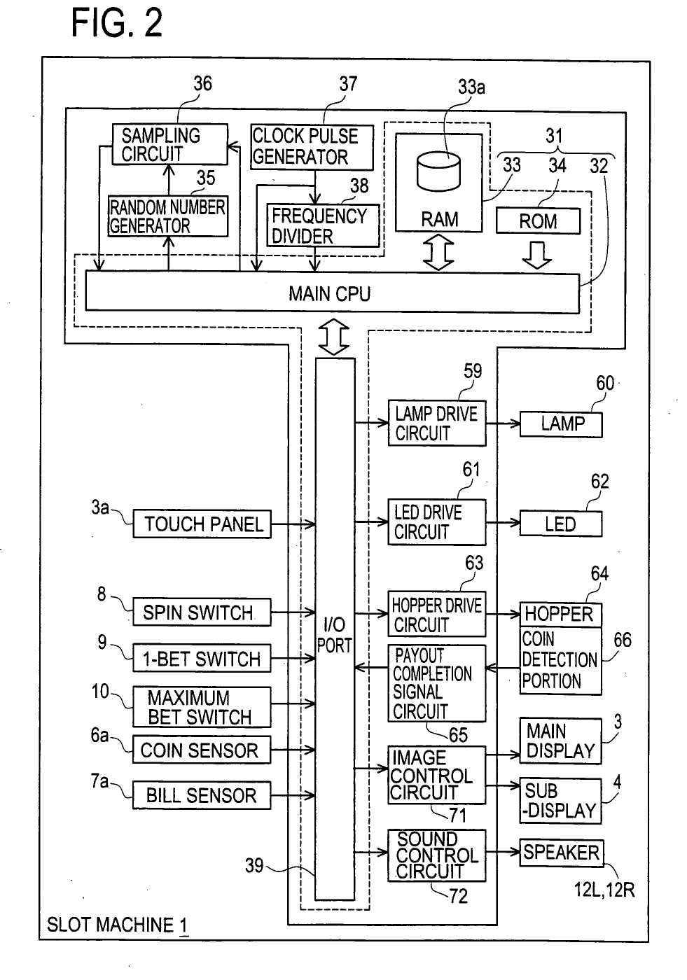

The coin insertion slot 6 is provided for inserting game media such as coins, medals and the like (abbreviated as “coin” hereinafter) which a player bets for a game, and has a coin sensor 6a (see FIG. 2) to output a signal indicating coin insertion. And the bill insertion slot 7 is provided so that the player can insert bills and has a bill sensor 7a (see FIG. 2) to output a signal indicating bill insertion. The spin switch 8 is provided so that the player can conduct operation to start the slot game during which the scroll image of symbols is displayed on each of the variable display portions 3A˜3I. The 1-BET switch 9 is provided to set one coin bet by one time operation thereof. The maximum BET switch 10 is provided to set the maximum coin bet through which the player can bet the maximum number of coins for one game, by one time operation thereof.

Further, in the slot machine 1, a coin payout opening 13 and a coin receiver 14 for receiving coins paid out are provided at a bottom position of the cabinet 2. And speakers 12L, 12R are respectively arranged at the left and the right sides of the coin payout opening 13.

FIG. 2 is a block diagram of the slot machine 1 showing an inner construction thereof. The slot machine 1 has a plurality of constructive elements mainly including a microcomputer 31.

The microcomputer 31 has a main CPU (Central Processing Unit) 32, a RAM (Random Access Memory) 33 and a ROM (Read Only Memory) 34. The microcomputer 31 operates as various devices characterized in the present invention according to programs stored in the ROM 34, and further conducts input and output of signals through an I/O port 39 with the other constructive elements, thereby the microcomputer 31 entirely controls operations of the slot machine 1. In the RAM 33, a payout correspondence table 33a is stored, and data and programs utilized when the main CPU 32 operates are further stored. For example, a random number value sampled by a sampling circuit 36 mentioned later is temporarily stored in the RAM 33 after the game is started. In the ROM 34, programs executed by the main CPU 32 and permanent data are stored.

And the slot machine 1 has a random number generator 35, a sampling circuit 36, a clock pulse generator 37 and a frequency divider 38. The random number generator 35 operates according to the instruction by the main CPU 32 and generates random numbers within a predetermined range. The sampling circuit 36 voluntarily extracts a random number among the random numbers generated by the random number generator 35 according to the instruction by the main CPU 32 and inputs the random number extracted to the main CPU 32. The clock pulse generator 37 generates standard clock pulses to operate the main CPU 32, and the frequency divider 38 inputs signals obtained by dividing the standard clock pluses with a predetermined period to the main CPU 32.

Further, the slot machine 1 has a touch panel 3a, a lamp drive circuit 59, a lamp 60, a LED drive circuit 61, a LED 62, a hopper drive circuit 63, a hopper 64, a payout completion signal circuit 65 and a coin detection portion 66. And the slot machine 1 has an image control circuit 71 and a sound control circuit 72.

The touch panel 3a is arranged so as to cover a display screen of the main display 3, detects a position of a place where a finger of the player touches and outputs a positional signal corresponding to the position detected to the main CPU 32. The lamp drive circuit 59 outputs to the lamp 60 a signal to blink thereof, thereby the lamp 60 is blinked while execution of the game. According to this blinking of the lamp 60, effects of the game is conducted. The LED drive circuit 61 controls blinking display of the LED 62. The LED 62 conducts credit number display and coin number display corresponding to coins obtained. The hopper drive circuit 63 drives the hopper 64 according to control by the main CPU 32, thereby the hopper 64 operates to pay out coins according to a winning symbol combination and pays out coins to the coin receiver 14 from the coin payout opening 13. The coin detection portion 66 measures a number of coins paid out through the hopper 64 and outputs data concerning with the measured number of coins paid out to the payout completion signal circuit 65. To the payout completion signal circuit 65, the data of number of coins paid out are input from the coin detection portion 66 and the payout completion signal circuit 65 outputs a coin payout completion signal to the main CPU 32 when such number value reaches to number data preset.

The image control circuit 71 respectively controls image display on both the main display 3 and the sub-display 4, thereby various images such as variable display images of plural symbols are displayed on each of the main display 3 and the sub-display 4.

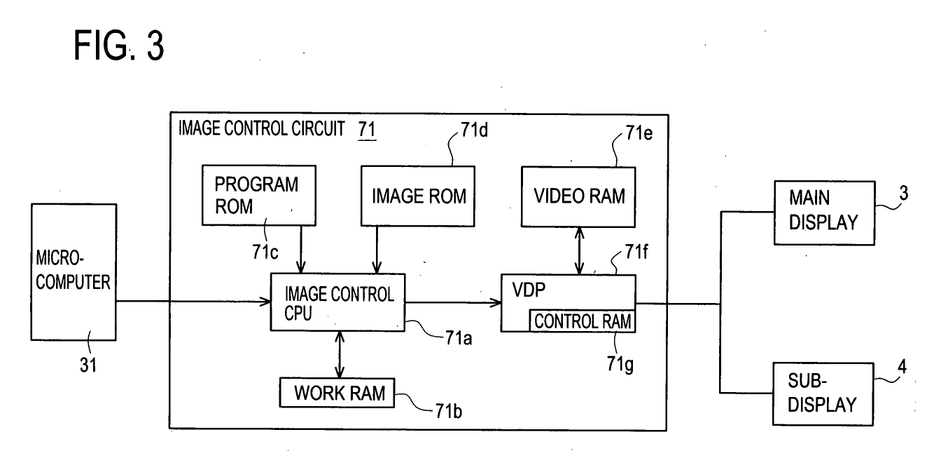

This image control circuit 71 has, as shown in FIG. 3, an image control CPU 71a, a work RAM 71b, a program ROM 71c, an image ROM 71d, a video RAM 71e and a VDP (Video Display Processor) 71f. The image control CPU 71a determines images displayed on the main display 3 and the sub-display 4 (payout information 4A˜4D, reel images, images of stop symbols displayed when the scroll display is stopped), according to the image control program (concerning with display conducted on the main display 3 and the sub-display 4) stored beforehand in the program ROM 71c, based on parameters set by the microcomputer 31. The work RAM 71b is constructed as a temporary memory when the image control CPU 71a executes the image control program.

The program ROM 71c stores the image control program and various selection tables. The image ROM 71d stores dot data for forming images. Among the dot data, symbol image data indicating each of symbols utilized in the base game and the bonus game are included in the first embodiment. The video RAM 71e is constructed as a temporary memory when images are formed by the VDP 71f. The VDP 71f has a control RAM 71g, and forms images corresponding to display contents of the main display 3 and the sub-display 4, the display contents being determined through the image control CPU 71a and outputs each of images formed according to the above to the main display 3 and the sub-display 4.

The sound control circuit 72 outputs to the speakers 12L, 12R sound signals to produce sounds therefrom. For example, sounds to raise interest for games are output from the speakers 12L, 12R at a voluntary timing after the game is started.

(Payout Correspondence Table)

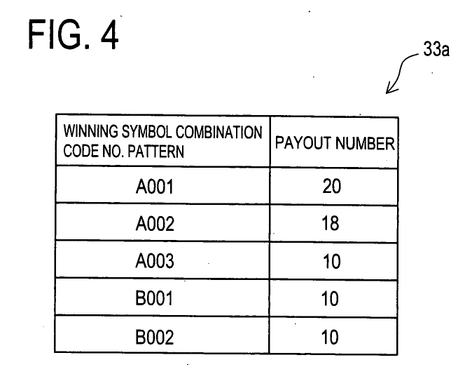

Next, a payout correspondence table 33a (payout correspondence data) stored in the RAM 33, which is used as the memory device in the present invention, will be described with reference to FIG. 4.

As shown in FIG. 4, in the payout correspondence table 33a, winning symbol combination code No. patterns and payout numbers each of which respectively corresponds to each of the winning symbol combination No. pattern are correlated with each other and stored. Here, the winning symbol combination code No. pattern means a code No. pattern inherent to each of the winning symbol combinations (namely, stop mode of symbols according to which payout is conducted), among code No. patterns (mentioned later) each of which is determined with a stop mode of the symbols stopped and displayed on the variable display portions 3A˜3I. In the payout correspondence table 33a, the payout number of winning symbol combination specified the winning symbol combination code No. pattern can be extracted by utilizing the winning symbol combination code No. pattern as a search key.

Here, in the slot machine 1, plural kinds of winning symbol combinations are prepared, and line winning symbol combinations and number winning symbol combinations are included in plural kinds of winning symbol combinations. The line winning symbol combination means a winning symbol combination concerning with symbol arrangement along the pay lines L1˜L8. For example, such line winning symbol combinations is defined as the winning symbol combination that the same three symbols are aligned along one of the pay lines L1˜L8. On the other hand, the number winning symbol combination means a winning symbol combination concerning with the number of predetermined symbols stopped and displayed on nine variable display portions 3A˜3I, with no relation to the pay lines. For example, the number winning symbol combination is defined as the winning symbol combination that more than three of the same predetermined symbols are displayed. Here, in the payout correspondence table 33a shown in FIG. 4, as for the winning symbol combination code No. pattern corresponding to the line winning symbol combination, the character “A” is attached to the left side thereof, and as for the winning symbol combination code No. pattern corresponding to the number winning symbol combination, the character “B” is attached to the left side thereof.

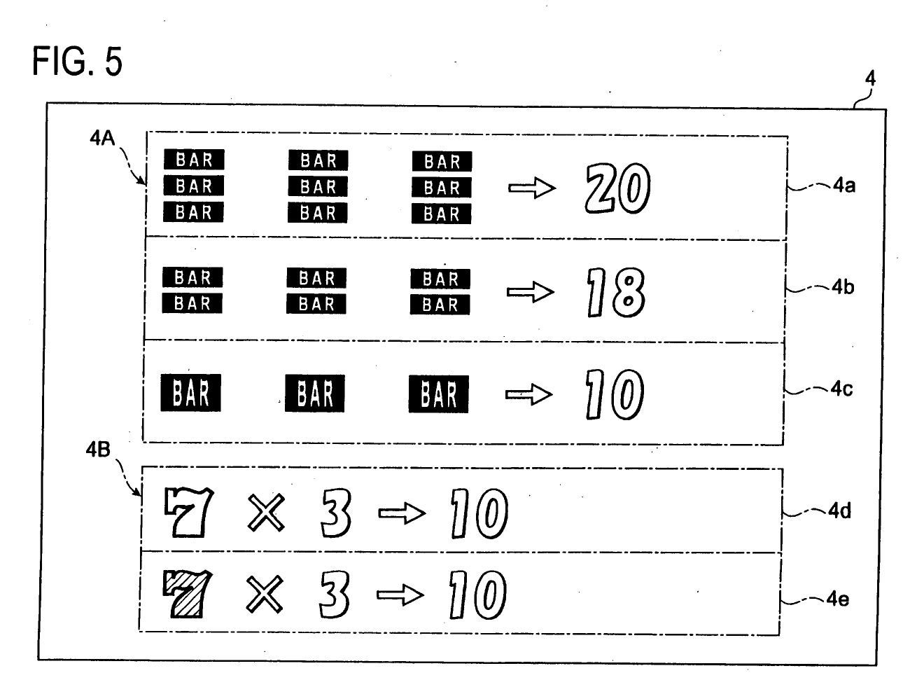

And the main CPU 32 displays the payout information 4A and 4B based on the payout correspondence table 33a stored in the RAM 33 on the sub-display 4, in cooperation with the image control circuit 71, as shown in FIG. 5. That is to say, the display control device in the present invention is constructed from both the main CPU 32 and the image control circuit 71.

In the payout information 4A, 4B, the stop mode of symbols of winning symbol combination specified by the winning symbol combination code No. pattern and the payout number are correspondingly arranged so that it can be easily understood a correspondence relation between the stop mode of symbols of winning symbol combination and the payout number. The payout information 4A, 4B is information to inform contents of the payout correspondence table 33a (that is, correspondence correlation between the winning symbol combination and the payout number) for the player. Therefore, the player can grasp the correspondence relation between the winning symbol combination and the payout number based on the payout information 4A, 4B displayed on the sub-display 4.

The payout information will be more concretely described. The payout information 4A is information concerning with the line winning symbol combination and the payout information 4A is constructed from three kinds of payout information 4a, 4b, 4c. The payout information 4a indicates the correspondence relation between the winning symbol combination code No. pattern “A001” and the payout number “20”. Similarly, the payout information 4b indicates the correspondence relation between the winning symbol combination code No. pattern “A002” and the payout number “18”. And the payout information 4c indicates the correspondence relation between the winning symbol combination code No. pattern “A003” and the payout number “10”.

And the payout information 4B is information concerning with the number winning symbol combination and the payout information 4B is constructed from two kinds of payout information 4d, 4e. And the payout information 4d indicates the correspondence relation between the winning symbol combination code No. pattern “B001” and the payout number “10” and the payout information 4e indicates the correspondence relation between the winning symbol combination code No. pattern “B002” and the payout number “10”.

(Operational Contents Of Slot Machine)

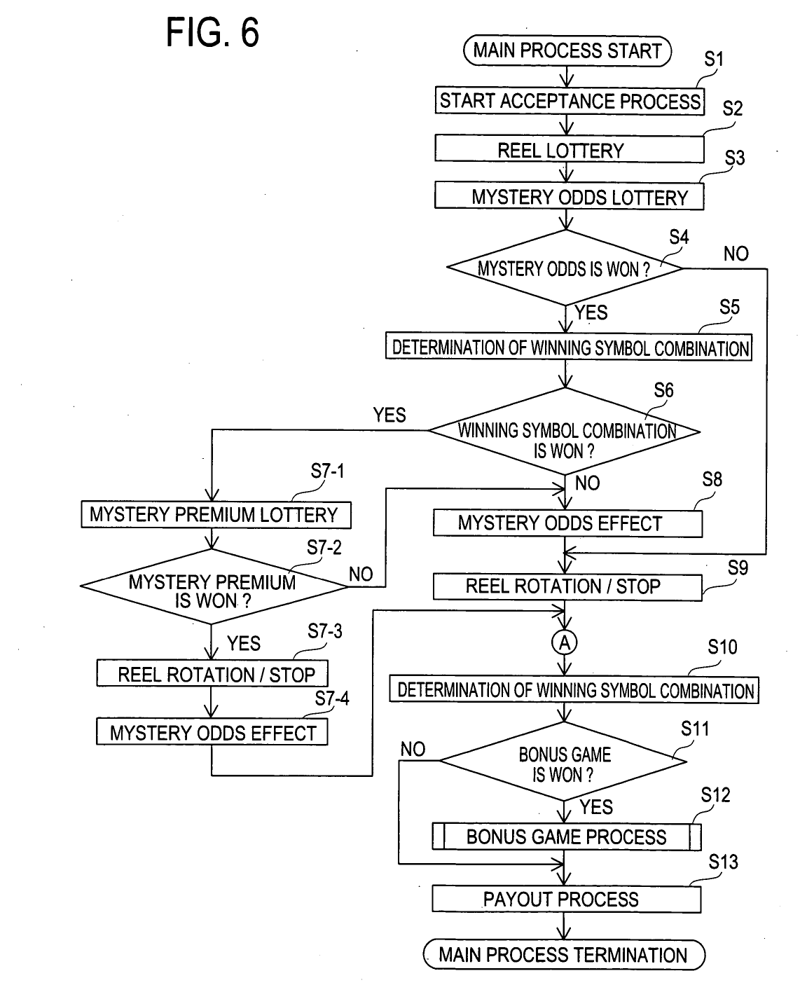

Next, operational contents of the slot machine 1 constructed according to the above will be described with reference to a flowchart shown in FIG. 6.

FIG. 6 is a flowchart showing procedures of a main process from a game start to an end thereof in the slot machine 1. Here, in flowcharts shown in Figs. including FIG. 6, each of steps is abbreviated as “S”.

In the slot machine 1, the main CPU 32 controls progress of the game, and as shown in FIG. 6, after the main process is started, a start acceptance process is first conducted in S1 at the game start.

In the start acceptance process, the slot machine 1 accepts the operation to start the game by the player according to control of the main CPU 32. Here, since the slot machine 1 is a gaming machine of coin insertion type, in order to start the game, the player first inserts coins with a number to bet for one game through the coin insertion slot 6. Or if credits are remained, the player operates the 1-BET switch 9 or the maximum BET switch 10. Continuous to this operation, the player operates the spin switch 8 (hereinafter, this operation is abbreviated as “start operation”). Based on the start operation, the start signal is input to the main CPU 32 from the spin switch 8. Here, when the start operation is conducted, the above mentioned payout information is displayed on the sub-display 4, by cooperation between the main CPU 32 and the image control circuit 71.

In S2, as a reel lottery process, the main CPU 32 operates as the symbol determination device, thereby a symbol determination process is conducted. In the symbol determination process, the main CPU 32 determines the symbols which are fixedly stopped on each of the variable display portions 3A˜3I after variable display is stopped (hereinafter, these symbols are called as “stop symbols”).

In the reel lottery process, when the main CPU 32 detects the start operation by the player based on the start signal, the main CPU 32 instructs the random number generator 35 to generate random numbers within a predetermined range, on the basis of detection of start operation (that is, corresponding to the game start). And the main CPU 32 instructs the sampling circuit 36 to extract a voluntary random number among the random numbers generated by the random number generator 35. When the random umber is extracted, the main CPU 32 refers a symbol determination table (table in which symbol code Nos. and random numbers are mutually corresponded and stored, not shown) by setting the random number extracted as a search key and obtains the symbol code No. corresponding to the random number.

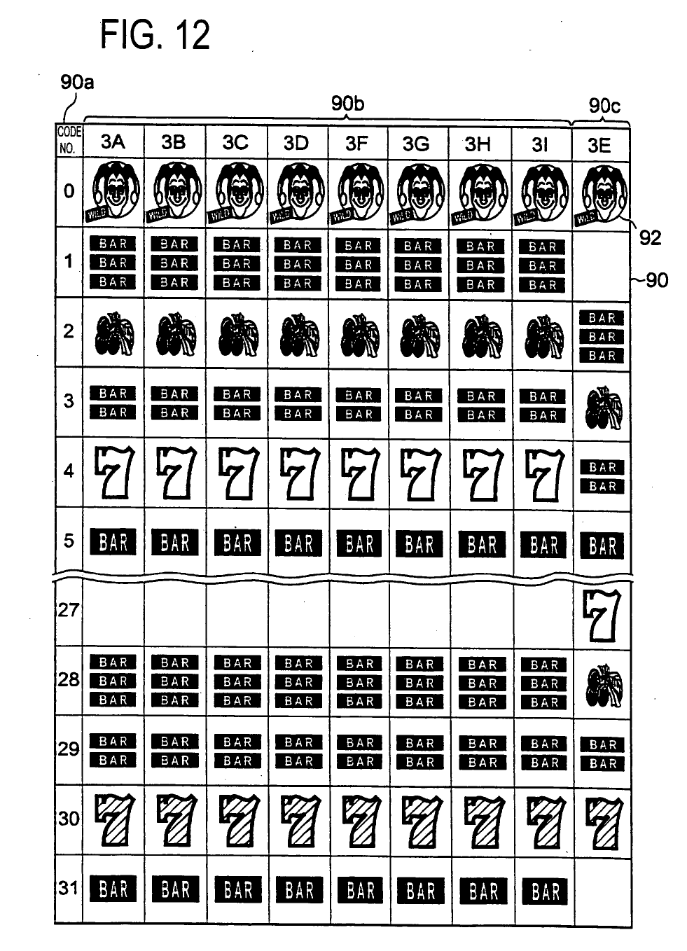

Next, the code No. obtained is set as a search key and the stop table 90 shown in FIG. 12 is referred, thereby the stop symbols to be stopped and displayed on each of the variable display portions 3A˜3I are retrieved.

Here, as shown in FIG. 12, the stop table 90 is a table which has a code No. 90a area storing code Nos. of symbols, a first symbol area 90b and a second symbol area 90c storing symbols corresponding to each of the code Nos. and each of symbols corresponding to each of the variable display portions 3A˜3I can be retrieved by searching the code No. area 90a after the code no. is set as a search key.

In the first symbol area 90b and the second symbol area 90c, the code of each of symbols is registered corresponding to each of the code Nos. “0”˜“31”. And in the first symbol area 90b, it is registered the codes of the stop symbols to be stopped and displayed on each of the variable display portions 3A˜3D, 3F˜3I except for the variable display portion 3E. And in the second symbol area 90c, it is registered the codes of the stop symbols to be stopped and displayed on the variable display portions 3E. In the first embodiment, the symbol (WILD joker 92) corresponding to the code No. “0” in the second symbol area 90c is a beneficial symbol. The WILD joker 92 has meaning to show the player that the WILD joker 29 is more beneficial than the other symbols, and as shown in FIG. 12, the WILD joker 29 is constructed by combining an image showing a man face and character line “WILD”.

And in the slot machine 1, extraction of the random number, search of the symbol determination table and the stop table 90 are conducted in nine times for each of the variable display portions 3A˜3I. That is to say, search is conducted in the number of times corresponding to the number of the variable display portions, thereby the stop symbol in each of the variable display portions 3A˜3I is determined.

Next, in S3, the main CPU 32 instructs the random number generator 35 to generate the random numbers within a predetermined range and instructs the sampling circuit 36 to extract a voluntary random number among the random numbers generated by the random number generator 35. By utilizing the random number extracted according to the above, the main CPU 32 conducts a lottery whether or not the game state shifts to a mystery odds state. Here, a probability to shift to the mystery odds state can be regulated to a desirable probability by changing a range of the random numbers generated.

Here, the mystery odds state is a game state that the payout correspondence table 33a mentioned above is changed to a different payout correspondence table (that is, a special payout correspondence table 33b mentioned later) and the payout information 4A, 4B displayed on the sub-display 4 is changed to different payout information (that is, special payout information 4C, 4D mentioned later).

And in S4, procedure shifts to a case that the game state shifts to the mystery odds state or a case that the game state does not shift to the mystery odds state. That is to say, if the game state shifts to the mystery odds state, procedure shifts to S5, and if the game state does not shift to the mystery odds state, procedure shifts to S9 and it is conducted a reel rotation/stop process.

In S5, the main CPU 32 determines for the stop symbols displayed on the variable display portions 3A˜3I whether or not the stop mode of the stop symbols corresponds to the winning symbol combination (that is, whether or not the winning symbol combination is won) by referring the payout correspondence table 33a. Namely, in the payout correspondence table 33a, it is confirmed whether or not a winning symbol combination code No. pattern corresponding to a combination of code Nos. of the stop symbols (hereinafter, abbreviated as “code No. pattern”) exists. In a case that the winning symbol combination code No. pattern corresponding thereto exists, it is determined that the code No. pattern corresponds to the winning symbol combination, and on the contrary, if the winning symbol combination code No. pattern corresponding thereto does not exist, the code No. pattern does not correspond to the winning symbol combination.

And in S6, procedure is diverged corresponding to whether or not the winning symbol combination is won. That is to say, if the winning symbol combination is won, procedure shifts to S7-1 and if the winning symbol combination is not won, procedure shifts to S8.

In S7-1, the main CPU 32 instructs the random number generator 35 to generate the random numbers within a predetermined range and instructs the sampling circuit 36 to extract a voluntary random number among the random numbers generated by the random number generator 35. By utilizing the random number generated according to the above, the main CPU 32 conducts a lottery whether or not a mystery premium is executed. Here, an execution probability of the mystery premium can be regulated to a desirable probability by changing a range of the random numbers generated.

And in S7-2, procedure shifts to a case that the mystery premium is executed or to a case that the mystery premium is not executed. That is to say, if the mystery premium is executed, procedure shifts to S7-3, and on the contrary, if the mystery premium is not executed, procedure shifts to S8.

In S7-3, the reel rotation/stop process is conducted. That is, at first, the reel rotation process is started and the image shown in FIG. 11 is displayed on the main display 3. Here, on the main display 3, nine variable display portions 3A˜3I mentioned in the above are displayed. And at an upper side of the main display 3, the character line “BONUS SPIN ACE” and a title display portion 83 including game explanation are displayed. Further, at a lower side of the main display 3, it is displayed a meter display portion 84 having a BET number display portion 84a, a PAID number display portion 84b, a coin insertion and payout display portion 48c and a credit number display portion 84d. Here, eight BET number display portions 82a indicating the BET number for each pay line are arranged so as to enclose the periphery of the variable display portions 3A˜3I.

And after the reel rotation process to variably display the symbols is conducted, the stop control process is executed, thereby scroll speed is lowered and the stop symbols corresponding to the result of reel lottery in S2 are displayed on each of the variable display portions 3A˜3I.

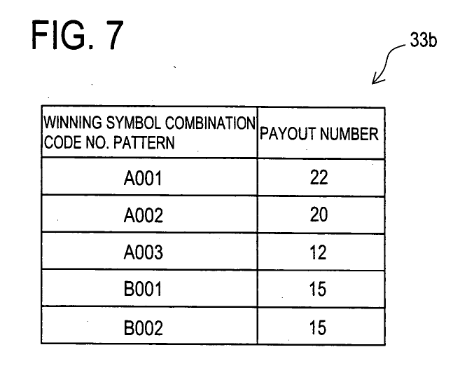

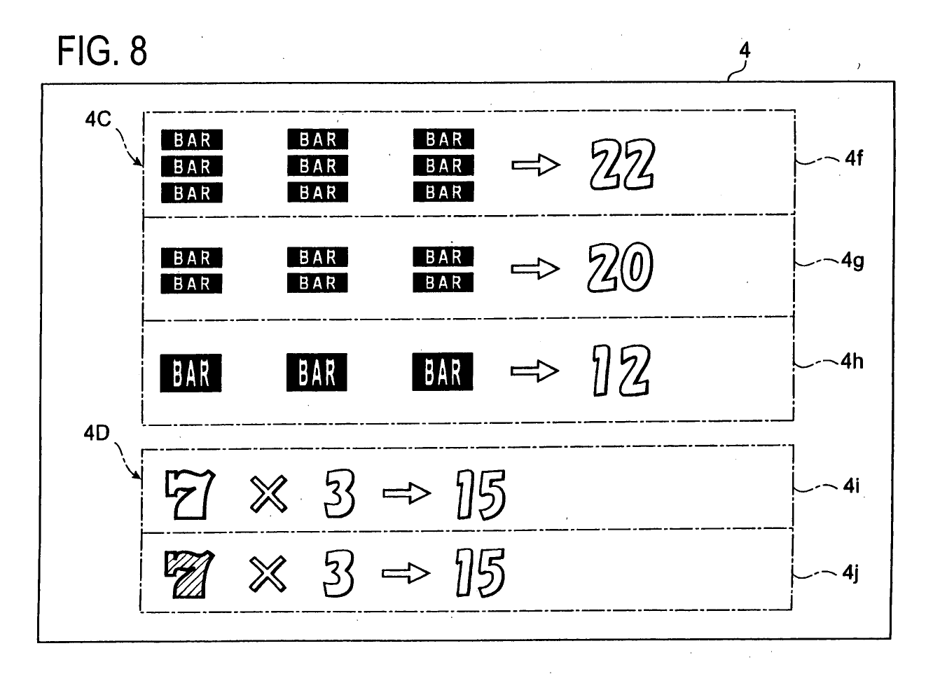

Thereafter, in S7-4, the main CPU 32 operates as the data change device in the present invention and changes the payout correspondence table 33a stored in the RAM 33 to the special payout correspondence table 33b shown in FIG. 7. And the main CPU 32 operates as the display control device in the present invention and displays the special payout information 4C, 4D shown in FIG. 8 on the sub-display 4 as the effect in the mystery odds state (abbreviated as “mystery odds effect), instead of the payout information 4A. 4B.

Here, in the special payout correspondence table 33b, 2 is respectively added to each of the payout numbers corresponding to each of the winning symbol combination code No. patterns (A001, A002, A003) of the line winning symbol combinations in the payout correspondence table 33a, and 5 is respectively added to each of the payout numbers corresponding to each of the winning symbol combination code No. patterns (B001, B002) of the number winning symbol combinations in the payout correspondence table 33a. That is to say, in the special payout correspondence table 33b, the payout number increases for all of the winning symbol combination code No. patterns, in comparison with the payout correspondence table 33a.

And the special payout information 4C, 4D is information to inform contents of the special payout correspondence table 33b to the player, and similar to the above payout information, the stop mode of the symbols of the winning symbol combination and the payout number are aligned and displayed so that it can be easily understood the correspondence relation between the stop mode of the symbols of the winning symbol combination specified by the winning symbol combination code No. pattern and the payout number corresponding to the winning symbol combination.

After the process in S7-4 is completed, procedure shifts to S10.

On the other hand, in S8, similar to S7-4 mentioned in the above, the main CPU 32 operates as the data change device in the present invention and changes the payout correspondence table 33a stored in the RAM 33 to the special payout correspondence table 33b. And the main CPU 32 operates as the display control device in the present invention and conducts the mystery odds effect on the sub-display 4.

And in S9 continuous to S8, similar to S7-3 mentioned in the above, the reel rotation/stop process is conducted, thereafter procedure shifts to S10.

That is to say, if the mystery premium is executed, the reel rotation/stop process is conducted and thereafter the mystery odds effect is executed. And if the mystery premium is not executed, the mystery odds effect is conducted and thereafter the reel rotation/stop process is conducted. In other words, corresponding to the lottery result of the mystery premium, execution order of the reel rotation/stop process and the mystery odds effect is exchanged.

In S10, the main CPU 32 again determines for the stop symbols on each of the variable display portions 3A˜3I determined in S2 whether or not the winning symbol combination is won with reference to the payout correspondence table 33a stored in the RAM 33. And if the winning symbol combination is won, the main CPU 32 operates as the payout process device and determines the payout number of th winning symbol combination corresponding to the stop mode of the stop symbols. Here, in S4, if the game state does not shift to the mystery odds state, the payout number is determined by utilizing the payout correspondence table 33a and if the game state shifts to the mystery odds state, the payout number is determined by utilizing the special payout correspondence table 33b.

Here, as mentioned, in the special payout correspondence table 33b, all payout numbers in the payout correspondence table 33a are increased. Therefore, in a case that the payout number is determined by utilizing the special payout correspondence table 33b, such payout number becomes larger than the payout number determined by utilizing the payout correspondence table 33a. That is to say, the special payout correspondence table 33b is more beneficial for the player in comparison with the payout correspondence table 33a.

And in S10, according to the shift condition to shift the game mode to the special game mode, it is also determined whether or not the game mode is to be shifted to the special game mode. And if the shift condition is realized (for example, the stop symbol on the variable display portion 3E is determined as the WILD joker 92), it is determined by the main CPU 32 that the game mode can be shifted to the special game mode. In addition to this, the shift condition may be realized according to the stop mode of a predetermined symbol.

Further in S11, procedure is diverged corresponding to a case that it is determined that the shift condition of the special game mode is realized and the game mode can be shifted or a case that it is determined that the game mode cannot be shifted. That is to say, if it is determined that the game mode can be shifted, procedure shifts to S12, and if it is determined that the game mode cannot be shifted, procedure shifts to S13 without execution of S12.

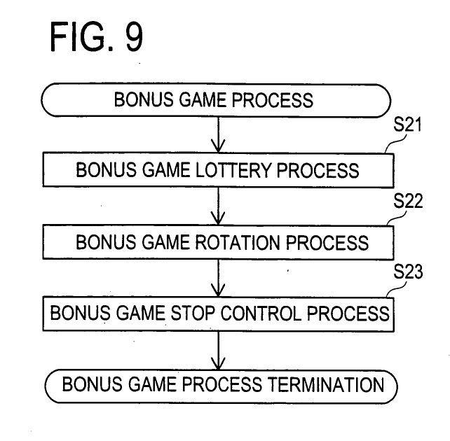

In S12, as shown in FIG. 9, a lottery process of the bonus game (S21), a rotation process as the operation necessary for the bonus game (S22) and a stop control process (S23) are sequentially conducted on the main display 3. And after process in S23 is executed, the bonus game is terminated.

Thereafter, in S13, the main CPU 32 operates as the payout process device, and as the payout process concerning with the payout number determined in S10 or the payout process concerning with the payout number confirmed in the bonus game, the main CPU 32 conducts the coin payout process for paying out coins with the number as same as the payout number or the addition process of credits with the number as same as the payout number. After these payout processes are completed, the main CPU 32 and the image control circuit 71 change the special payout correspondence table 33b of the RAM 33 to the payout correspondence table 33a and change the special payout information 4C, 4D displayed on the sub-display 4 to the payout information 4A, 4B, thereafter the main process is terminated.

As mentioned in the above, in the slot machine 1, in a case that the game state shifts to the mystery odds state in S4, change of the payout correspondence table 33a in the RAM 33 and the mystery odds effect are conducted, in spite whether or not the winning symbol combination is won. And in the mystery odds effect, the payout information 4A, 4B displayed on the sub-display 4 up to the present is changed to the special payout information 4C, 4D. The special payout information 4C, 4D cannot be confirmed by player till the mystery odds effect is conducted, therefore the payout number cannot be substantially predicted by the player. As a result, unexpected feeling can be raised for the player, thus interest for games can be surely realized.

And since shift to the mystery odds state is determined with a predetermined probability on the basis of the random number, unexpected feeling of the game and payout can be effectively raised. Here, shift to the mystery odds state can be also conducted according to realization of a predetermined condition such as appearance of the predetermined stop mode of symbols in the game, in addition that shift to the mystery odds state is conducted according to the predetermined probability.

And in a case that the mystery odds effect is executed (S7-4) after the reel stop control process (S7-3) is conducted, the winning symbol combination is won (S6: YES) and the payout process is executed by utilizing the special payout correspondence table 33b, therefore expectation of the player for high payout can be effectively raised when the mystery odds effect is conducted.

On the other hand, in a case that the mystery odds effect (S8) is execute before the reel rotation/stop process (S9) is conducted, there may be two cases in one of which the winning symbol combination is won and in the other of which the winning symbol combination is not won. If the winning symbol combination is won, high payout can be expected by the payout process utilizing the special payout correspondence table 33b, thus expectation of the player for high payout can be effectively retained till the reel stop control process is done and the stop symbols are displayed (that is, during rotation of the reels).

In addition to the above, based on that execution order of the reel rotation/stop process and he mystery odds effect is exchanged corresponding to the lottery result with a predetermined probability in the mystery premium, the player can unexpectedly obtain high payout according to that the mystery odds effect appears at an unexpected timing. Thus, unexpected feeling of the payout can be also raised in the slot machine 1. In addition, since the same bonus contents can be produced and realized at plural timings, it is difficult for the player to predict the payout.

Here, as mentioned in the above, in the operation procedure of the slot machine 1 according to the flowchart shown in FIG. 6, although it is shown in the first embodiment that the payout process utilizing the special payout correspondence table 33b and the mystery odds effect of the special payout information 4C, 4D are completed during one game, the payout process utilizing the special payout correspondence table 33b and the mystery odds effect of the special payout information 4C, 4D may be retained over plural games.

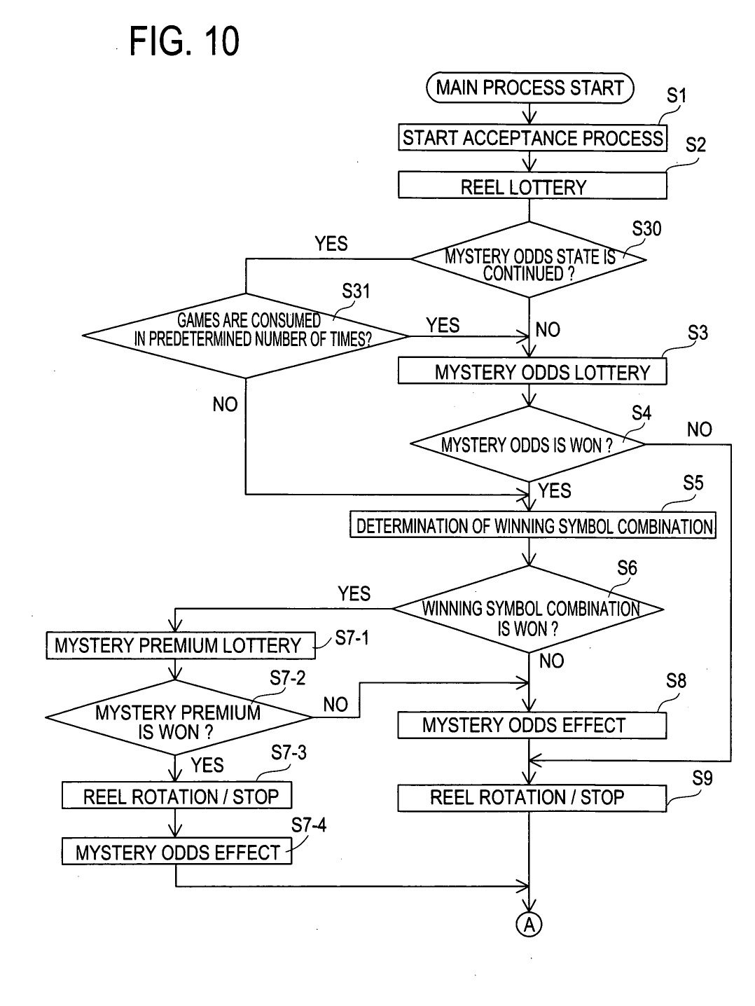

In the example shown in a flowchart of FIG. 10, after the game state once shifts to the mystery odds state, the mystery odds state is retained till games are consumed (conducted) in a predetermined number of times (for example, 10 times). The flowchart shown in FIG. 10 is as same as the flowchart shown in FIG. 6, except for S30 and S31. Therefore, since the processes after “A” are as same as those in FIG. 6 after “A”, such processes are omitted.

And in the operation procedure of the slot machine 1 according to the flowchart of FIG. 10, after the stop symbols (reel lottery) are determined, the main CPU 32 determines whether or not the mystery odds state is continued from the previous game. And if it is determined that the mystery odds state is not continued from the previous game, procedure shifts to S3 and the lottery to determine whether or not the game state shifts to the mystery odds state is again conducted. On the other hand, if the mystery odds state is continued from the previous game, procedure shifts to S31 and it is confirmed that the games are not consumed in a predetermined number of times. Thereafter, procedure shifts to S5 while the mystery odds state is retained in the present game. Here, even if the mystery odds state is continued from the previous game, in a case that the games are consumed in a predetermined number of times, procedure shifts to S3 and the lottery to determine whether or not the game state shifts to the mystery odds state is conducted.

In the procedure according to the flowchart of FIG. 10, in addition to the above effects, effects can be obtained as follows. That is to say, while the mystery odds state is continued over plural games, the special payout correspondence table 33b is always utilized in the payout process. Therefore, the player can continue games while holding expectation to get high payout. Thus, interest of the player for games in the slot machine 1 can be retained for a long time.

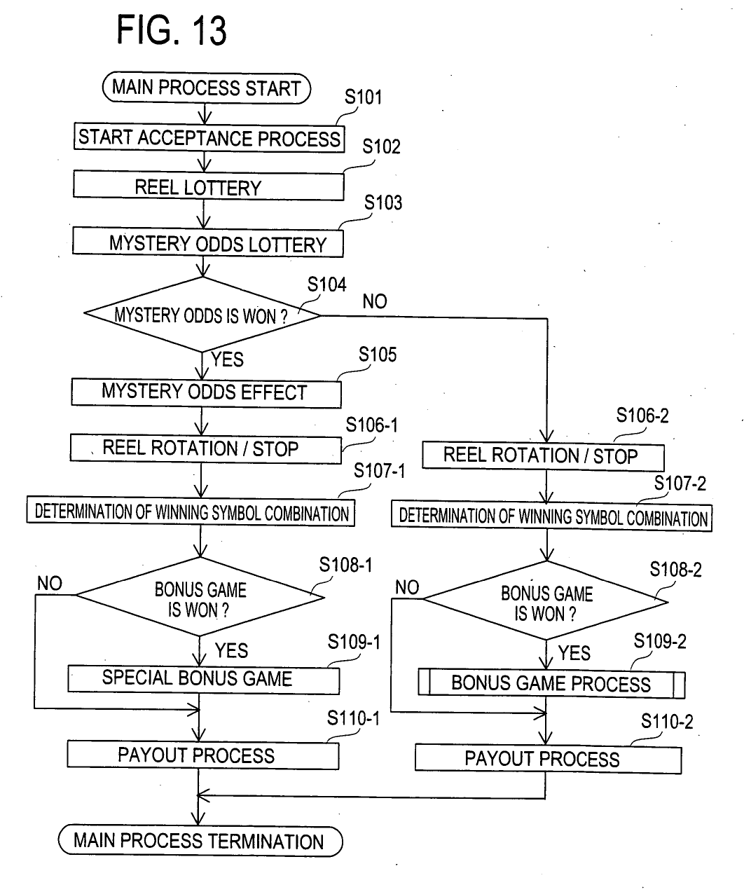

Next, the second embodiment of the present invention will be described with reference to FIGS. 13 to 15.

Here, the slot machine according to the second embodiment has the same construction as that of the first embodiment. Therefore, the construction of the slot machine 1 according to the second embodiment will be omitted.

First, operation contents of the slot machine 1 according to the second embodiment will be described with reference to a flowchart shown in FIG. 13. FIG. 13 is a flowchart showing procedures of a main process from a game start to an end thereof in the slot machine 1.

In the slot machine 1, the main CPU 32 controls progress of the game, and as shown in FIG. 13, after the main process is started, a start acceptance process is first conducted in S101 at the game start.

In the start acceptance process, the slot machine 1 accepts the operation to start the game by the player according to control of the main CPU 32. Here, since the slot machine 1 is a gaming machine of coin insertion type, in order to start the game, the player first inserts coins with a number to bet for one game through the coin insertion slot 6. Or if credits are remained, the player operates the 1-BET switch 9 or the maximum BET switch 10. Continuous to this operation, the player operates the spin switch 8 (hereinafter, this operation is abbreviated as “start operation”). Based on the start operation, the start signal is input to the main CPU 32 from the spin switch 8. Here, when the start operation is conducted, the above mentioned payout information is displayed on the sub-display 4, by cooperation between the main CPU 32 and the image control circuit 71.

In S102, as a reel lottery process, the main CPU 32 operates as the symbol determination device, thereby a symbol determination process is conducted. In the symbol determination process, the main CPU 32 determines the symbols which are fixedly stopped on each of the variable display portions 3A˜3I after variable display is stopped (hereinafter, these symbols are called as “stop symbols”).

In the reel lottery process, when the main CPU 32 detects the start operation by the player based on the start signal, the main CPU 32 instructs the random number generator 35 to generate random numbers within a predetermined range, on the basis of detection of start operation (that is, corresponding to the game start). And the main CPU 32 instructs the sampling circuit 36 to extract a voluntary random number among the random numbers generated by the random number generator 35. When the random umber is extracted, the main CPU 32 refers a symbol determination table (table in which symbol code Nos. and random numbers are mutually corresponded and stored, not shown) by setting the random number extracted as a search key and obtains the symbol code No. corresponding to the random number.

Next, the code No. obtained is set as a search key and the stop table 90 shown in FIG. 12 is referred, thereby the stop symbols to be stopped and displayed on each of the variable display portions 3A˜3I are retrieved.

Here, as shown in FIG. 12, the stop table 90 is a table which has a code No. 90a area storing code Nos. of symbols, a first symbol area 90b and a second symbol area 90c storing symbols corresponding to each of the code Nos. and each of symbols corresponding to each of the variable display portions 3A˜3I can be retrieved by searching the code No. area 90a after the code no. is set as a search key.

In the first symbol area 90b and the second symbol area 90c, the code of each of symbols is registered corresponding to each of the code Nos. “0”˜“31”. And in the first symbol area 90b, it is registered the codes of the stop symbols to be stopped and displayed on each of the variable display portions 3A˜3D, 3F˜3I except for the variable display portion 3E. And in the second symbol area 90c, it is registered the codes of the stop symbols to be stopped and displayed on the variable display portions 3E. In the first embodiment, the symbol (WILD joker 92) corresponding to the code No. “0” in the second symbol area 90c is a beneficial symbol. The WILD joker 92 has meaning to show the player that the WILD joker 29 is more beneficial than the other symbols, and as shown in FIG. 12, the WILD joker 29 is constructed by combining an image showing a man face and character line “WILD”.

And in the slot machine 1, extraction of the random number, search of the symbol determination table and the stop table 90 are conducted in nine times for each of the variable display portions 3A˜3I. That is to say, search is conducted in the number of times corresponding to the number of the variable display portions, thereby the stop symbol in each of the variable display portions 3A˜3I is determined.

Next, in S103, the main CPU 32 instructs the random number generator 35 to generate the random numbers within a predetermined range and instructs the sampling circuit 36 to extract a voluntary random number among the random numbers generated by the random number generator 35. At that time, the main CPU 32 operates as the shift determination device and conducts a lottery utilizing the above random number extracted according to the above, in order to determine whether or not a shift condition to shift the game state to a mystery odds state (specific game state) is realized. Here, a probability to shift to the mystery odds state can be regulated to a desirable probability by changing a range of the random numbers generated. In addition, the shift condition may be realized according to the stop mode of predetermined symbols.

Here, the mystery odds state is a game state that the payout correspondence table 33a mentioned above is changed to a different payout correspondence table (that is, a special payout correspondence table 33b mentioned later) and the payout information 4A, 4B displayed on the sub-display 4 is changed to different payout information (that is, special payout information 4C, 4D mentioned later).

And in S104, based on winning of the mystery odds state in S103 (that is, realization of the shift condition), the main CPU 32 operates as the first shift device and shifts the game state to the mystery odds state. And in a case that the game state shifts to the mystery odds state, procedure shifts to S105. On the other hand, in a case that the game state does not shift to the mystery odds state, procedure shifts to S106-2.

In S105, the main CPU 32 changes the payout correspondence table 33a stored in the RAM 33 to the special payout correspondence table 33b shown in FIG. 7. And the main CPU 32 displays the special payout information 4C, 4D shown in FIG. 8 on the sub-display 4 as the effect in the mystery odds state (abbreviated as “mystery odds effect), instead of the payout information 4A. 4B.

Here, in the special payout correspondence table 33b, 2 is respectively added to each of the payout numbers corresponding to each of the winning symbol combination code No. patterns (A001, A002, A003) of the line winning symbol combinations in the payout correspondence table 33a, and 5 is respectively added to each of the payout numbers corresponding to each of the winning symbol combination code No. patterns (B001, B002) of the number winning symbol combinations in the payout correspondence table 33a. That is to say, in the special payout correspondence table 33b, the payout number increases for all of the winning symbol combination code No. patterns, in comparison with the payout correspondence table 33a.

And the special payout information 4C, 4D is information to inform contents of the special payout correspondence table 33b to the player, and similar to the above payout information, the stop mode of the symbols of the winning symbol combination and the payout number are aligned and displayed so that it can be easily understood the correspondence relation between the stop mode of the symbols of the winning symbol combination specified by the winning symbol combination code No. pattern and the payout number corresponding to the winning symbol combination.

In S106-1, the reel rotation/stop process is conducted. That is, at first, the reel rotation process is started and the image shown in FIG. 11 is displayed on the main display 3. Here, on the main display 3, nine variable display portions 3A˜3I mentioned in the above are displayed. And at an upper side of the main display 3, the character line “BONUS SPIN ACE” and a title display portion 83 including game explanation are displayed. Further, at a lower side of the main display 3, it is displayed a meter display portion 84 having a BET number display portion 84a, a PAID number display portion 84b, a coin insertion and payout display portion 48c and a credit number display portion 84d. Here, eight BET number display portions 82a indicating the BET number for each pay line are arranged so as to enclose the periphery of the variable display portions 3A˜3I.

And after the reel rotation process to variably display the symbols is conducted, the stop control process is executed, thereby scroll speed is lowered and the stop symbols corresponding to the result of reel lottery in S102 are displayed on each of the variable display portions 3A˜3I.

In S107-1, the main CPU 32 determines for the stop symbols displayed on the variable display portions 3A˜3I whether or not the stop mode of the stop symbols corresponds to the winning symbol combination (that is, whether or not the winning symbol combination is won) by referring the payout correspondence table 33a. More concretely, in the payout correspondence table 33a, it is confirmed whether or not a winning symbol combination code No. pattern corresponding to a combination of code Nos. of the stop symbols (hereinafter, abbreviated as “code No. pattern”) exists. In a case that the winning symbol combination code No. pattern corresponding thereto exists, it is determined that the code No. pattern corresponds to the winning symbol combination, and on the contrary, if the winning symbol combination code No. pattern corresponding thereto does not exist, the code No. pattern does not correspond to the winning symbol combination. And if the winning symbol combination is won, the main CPU 32 determines the payout number of the winning symbol combination corresponding to the stop mode of the stop symbols.

Here, as mentioned, in the special payout correspondence table 33b, all payout numbers in the payout correspondence table 33a are increased. Therefore, in a case that the payout number is determined by utilizing the special payout correspondence table 33b, such payout number becomes larger than the payout number determined by utilizing the payout correspondence table 33a. That is to say, the special payout correspondence table 33b is more beneficial for the player in comparison with the payout correspondence table 33a.

And in S107-1, the main CPU 32 operates as the second shift determination device and determines whether or not a shift condition to shift the game state to a bonus game (first special game mode) is realized. And if the shift condition is realized (for example, the stop symbol on the variable display portion 3E is determined as the WILD joker 92), it is determined by the main CPU 32 that the game mode can be shifted to the special game mode. In addition to this, the shift condition may be realized according to the stop mode of a predetermined symbol.

And in S108-1, if the shift condition of the bonus game is realized in S107-1, the main CPU 32 operates as the second shift device and shifts the game state to a special bonus game state (second special game state) which is different from the bonus game state. And in a case that the game state is shifted to the special bonus game state, procedure shifts to S109-1, and on the contrary, in a case that the shift condition of the bonus game is not realized, procedure shifts to S110-1 without executing the process in S109-1.

In S109-1, the game mode is shifted to the special bonus game state which is defined as the special game mode different from the bonus game state. And in the special bonus game state, a special bonus game is conducted. This special bonus game is defined as combination of free games (games similar to the base game are conducted without consuming game media such as medals and the like) in a predetermined number of times (for example, 10 times) and the mystery odds game utilizing the special payout correspondence table 33b. In the special bonus game state, free games are conducted in a predetermined number of times under a high payout condition in which the special payout correspondence table 33b is utilized.

Thereafter, in S110-1, as the payout process concerning with the payout number determined in S107-1 or the payout process concerning with the payout number confirmed in the special bonus game, the main CPU 32 conducts the coin payout process for paying out coins with the number as same as the payout number or the addition process of credits with the number as same as the payout number. After these payout processes are completed, the main CPU 32 and the image control circuit 71 change the special payout correspondence table 33b of the RAM 33 to the payout correspondence table 33a and change the special payout information 4C, 4D displayed on the sub-display 4 to the payout information 4A, 4B, thereafter the main process is terminated.

On the other hand, in S104, if it is determined that the game state does not shift to the mystery odds state, procedure shifts to S106-2 and the reel rotation/stop process is conducted similarly to S106-1 mentioned in the above. Thereby, scroll speed is lowered and the stop symbols corresponding to the reel lottery result in S102 are displayed on each of the variable display portions 3A˜3I.

And in S107-2, similar to the process in S107-1, the main CPU 32 determines for the stop symbols on each of the variable display portions 3A˜3I determined in S102 whether or not the winning symbol combination is won by referring the payout correspondence table 33a stored on the RAM 33. And if it is determined that the winning symbol combination is won, the man CPU 32 determines the payout number of the winning symbol combination corresponding to the stop mode of the stop symbols.

And also in S107-2, similar to the process in S107-1, the main CPU 32 operates as the second shift determination device and determines whether or not the shift condition to shift the game state to the bonus game (first special game mode) is realized. And if it is determined that the shift condition is realized, it is determined by the main CPU 32 that the game state can be shifted to the bonus game. In addition, the shift condition may be realized according to the stop mode of a predetermined stop symbol.

Further, in S108-2, if the shift condition of the bonus game is realized in S107-2, the main CPU 32 operates as the third shift device and shifts the game state to the bonus game state. And in a case that the game state is shifted to the bonus game state, procedure shifts to S109-2, and free games are conducted in a predetermined number of times. On the other hand, if the shift condition of the bonus game is not realized, procedure shifts to S110-2 without executing the process in S109-2.

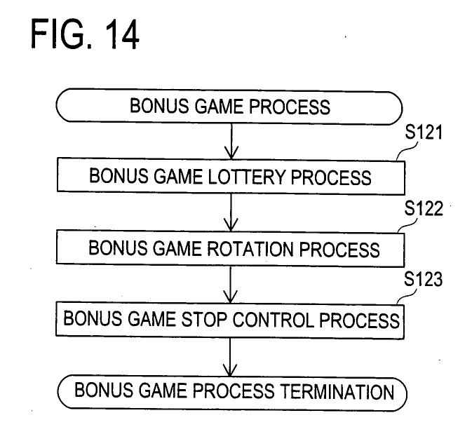

In S109-2, as shown in FIG. 14, a lottery process of the bonus game (S121), a rotation process as the operation necessary for the bonus game (S122) and a stop control process (S123) are sequentially conducted on the main display 3. And after the process in S123 is executed, the bonus game is terminated.

Thereafter, in S110-2, as the payout process concerning with the payout number determined in S107-2 or the payout process concerning with the payout number confirmed in the bonus game, the main CPU 32 conducts the coin payout process for paying out coins with the number as same as the payout number or the addition process of credits with the number as same as the payout number. After these payout processes are completed, the main CPU 32 and the image control circuit 71 change the special payout correspondence table 33b of the RAM 33 to the payout correspondence table 33a and change the special payout information 4C, 4D displayed on the sub-display 4 to the payout information 4A, 4B, thereafter the main process is terminated.

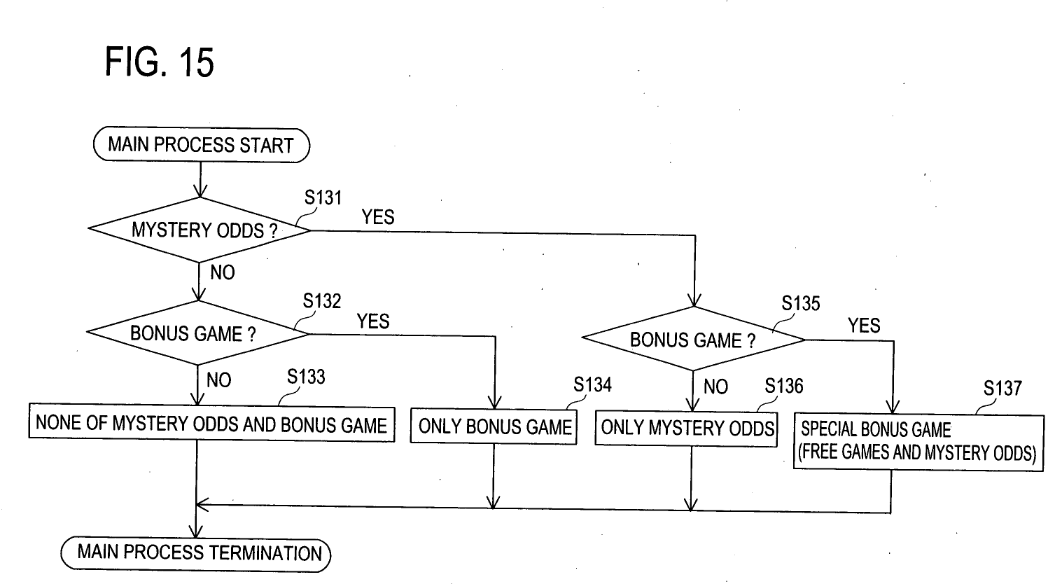

Change of the game state in the slot machine 1 mentioned above will be explained with reference to FIG. 15.

In the procedure of the slot machine 1, at first, in S103 of FIG. 13 (in S131 of FIG. 15), it is determined whether or not the shift condition to the mystery odds state is realized. And if it is determined that the shift condition to shift to the mystery odds state is not realized, it is further determined in S107-2 of FIG. 13 (in S132 of FIG. 15) whether or not the shift condition to shift to the bonus game state is realized. In this S132, if it is determined that the shift condition to shift to the bonus game state is not realized, the main process is terminated without merits of the mystery odds and the bonus game. On the other hand, in S132, if the shift condition to shift to the bonus game state is realized, the main CPU 32 operates as the third shift device and the game state shifts to the bonus game state.

Here, in S131, if the shift condition to shift to the mystery odds state is realized, the main CPU 32 operates as the first shift device and the game state shifts to the mystery odds state. Next, it is determined in S107-1 of FIG. 13 (in S135 of FIG. 15) whether or not the shift condition to shift to the bonus game state is realized. In this S135, if it is determined that the shift condition to shift to the bonus game state is not realized, the game state retains to the mystery odds state (S136 of FIG. 15).

On the other hand, in S135, if the shift condition to shift to the bonus game state is realized, two shift conditions are realized by combining realization of the shift condition of the mystery odds state in S131. At that time, the main CPU 32 operates as the second shift device and the game state shifts to the special bonus game state.

As mentioned in the above, in the slot machine 1, in addition to the base game state, there are provided the bonus game state and the mystery odds state, both states being mutually different and the special bonus game state as the special game mode different from the bonus game state and the mystery odds state. And in the special bonus game in the special bonus game state, free games as the bonus game are conducted by utilizing the special payout correspondence table 33b used in the mystery odds state, thereby the special bonus game becomes different from both the game in the mystery odds state and the bonus game. Therefore, by realization of the shift condition of the mystery odds state and the bonus game state, when the game state shifts to the special bonus game state, the game in the mystery odds state and the special bonus game characteristic of which is different from that of the bonus game, are conducted. As a result, in comparison with the conventional gaming machine in which only any one of the special games (bonus game and the like) is selectively realized, interest of the player for games can be efficiently raised in the slot machine 1 of the second embodiment.

And in the slot machine 1, as a case that the shift condition to shift to the bonus game state in S135 of FIG. 15 is determined, when the shift condition to shift to the special game state which is realizable is changed to one condition from two conditions, the game state is drastically changed to the special bonus game state from the mystery odds state. Thereby, high unexpected feeling can be realized for the player.

Here, in the mystery odds effect mentioned in the above, the payout information 4A, 4B displayed on the sub-display 4 is changed to the special payout information 4C, 4D. This special payout information 4C, 4D cannot be confirmed by the player till the mystery odds effect is conducted, thus the payout number cannot be substantially predicted by the player. As a result, unexpected feeling of the payout can be raised for the player and interest for games can be improved in the slot machine 1.

Shift to the mystery odds state is conducted on the basis of a predetermined probability by utilizing the random number, thereby unexpected feeling of the game and the payout can be effectively raised. Here, shift to the mystery odds state may be conducted according to realization of a predetermined condition such as appearance of the stop mode of a predetermined symbol.

Here, the present invention is not limited to the embodiments, and various modifications can be done within the scope of the present invention. For example, as for each of the payout numbers in the special payout correspondence table 33b, only a part of the payout numbers (for example, only the payout number corresponding to the line winning symbol combination or only the payout number corresponding to the number winning symbol combination) may be increased, without increasing all of the payout numbers in the payout correspondence table 33a. And in the special payout correspondence table 33b, the winning symbol combination code No. patterns in the payout correspondence table 33a may be changed.

And in the second embodiment, for example, the special game mode different from the bonus game state is not limited to the special bonus game state. Various special game modes (for example, plural images displayed on the display are selected by the player and the payout of a predetermined payout number is conducted corresponding to such selection) may be adopted.

Further, change of the payout correspondence table 33a in the RAM 33 and the mystery odds effect are not necessarily conducted at the same process timing. For example, only change of the payout correspondence table 33a may be conducted beforehand, and thereafter, only the mystery odds effect may be conducted at a desirable timing. And the payout process utilizing the special payout correspondence table 33b may be voluntarily adopted for the bonus game without adopting for only the base game.

Here, in the first and second embodiments, although nine variable display portions are provided, the number of the variable display portions is not limited to nine. Such number of the variable display portions may be three or five. And the variable display portions may be aligned along a straight line corresponding to the number thereof, so that the variable display portions are horizontally aligned along one row (for example, in a case that the number of the variable display portions is three).

What is claimed is:

1. A gaming machine including a display device having a plurality of variable display portions on each of which a symbol is variably displayed, wherein when a stop mode of the symbols stopped and displayed on the variable display portions corresponds to a winning symbol combination, a payout with a payout number corresponding to the winning symbol combination is conducted,
the gaming machine further comprising:
a memory device for storing payout correspondence data in which a correlation between the winning symbol combination and the payout number is set;
a display control device for controlling the display device so as to display payout information indicating the correlation;
a symbol determination device for determining the symbols stopped and displayed on the variable display portions of the display device;
a payout process device for conducting a payout process corresponding to the payout number correlated with the winning symbol combination based on the payout correspondence data stored in the memory device, when the stop mode of the symbols determined by the symbol determination device corresponds to the winning symbol combination in the payout correspondence data; and
a data change device for changing the payout correspondence data stored in the memory device to special payout correspondence data which are more beneficial than the payout correspondence data;
wherein when the payout correspondence data are changed to the special payout correspondence data by the data change device, the display control device controls the display device so as to display special payout information based on the special payout correspondence data instead of the payout information and the payout process device conducts the payout process according to the special payout correspondence data instead of the payout correspondence data.

2. The gaming machine according to claim 1, further comprising:
a first determination device for determining whether or not a game state shifts to a specific game state;
wherein the data change device changes the payout correspondence data to the special payout correspondence data if the first determination device determines that the game state sifts to the specific game state.

3. The gaming machine according to claim 2, wherein the data change device changes the payout correspondence data to the special payout correspondence data when the stop mode of the symbols determined by the symbol determination device corresponds to the winning symbol combination.

4. The gaming machine according to claim 3, wherein the display control device controls the display device so as to display the special payout information after the symbols determined by the symbol determination device are stopped and displayed on the variable display portions.

5. The gaming machine according to claim 2, wherein the display control device controls the display device so as to display the special payout information before the symbols determined by the symbol determination device are stopped and displayed on the variable display portions when the stop mode of the symbols determined by the symbol determination device does not correspond to the winning symbol combination.

6. The gaming machine according to claim 2, further comprising:
a second determination device for determining whether or not the specific game state continues from a previous game;
a continuation device for continuing the specific game state over plural games when the second determination device determines that the specific game state continues from the previous game.

7. The gaming machine according to claim 6, wherein the data change device changes the payout correspondence data to the special payout correspondence data while the continuation device continues the specific game state over plural games.

8. The gaming machine according to claim 1, wherein the payout information includes a first payout number and the special payout information includes a second payout number, and
wherein the second payout number is set by adding a predetermined number to the first payout number.

9. The gaming machine according to claim 1, wherein the data change device changes the payout correspondence data to the special payout correspondence data with a predetermined probability by changing a range of random numbers utilized in a lottery.

10. A gaming machine having a base game state in which a base game is conducted, a specific game state in which a specific game is conducted, a first special game state in which a first special game is conducted and a second special game state in which a second special game is conducted,
the gaming machine further comprising:
a first shift determination device for determining whether or not a first shift condition to shift the base game state to the specific game state is realized;
a second shift determination device for determining whether or not a second shift condition to shift the base game state to the first special game state is realized;
a first shift device for shifting the base game state to the specific game state when the first shift determination device determines that the first shift condition is realized; and
a second shift device for shifting the base game state to the second special game state when the first shift determination device determines that the first shift condition is realized and the second shift determination device determines that the second shift condition is realized.

11. The gaming machine according to claim 10, further comprising:
a third shift device for shifting the base game state to the first special game state when the first shift determination device determines that the first shift condition is not realized and the second shift determination device determines that the second shift condition is realized.

12. The gaming machine according to claim 10, wherein when the first shift determination device determines that the first shift condition is not realized and the second shift determination device determines that the second shift condition is not realized, the base game state is retained.

13. The gaming machine according to claim 10, further comprising:
a first memory device for storing payout correspondence data in which a first correlation between a winning symbol combination and a payout number is set, the first memory device being utilized when a payout is conducted based on that the first shift condition is not realized;
a second memory device for storing specific correspondence data in which a second correlation between the winning symbol combination and the payout number is set, the second memory device being utilized when the payout is conducted based on that the first shift condition is realized;
wherein the payout number of the winning symbol combination in the second correlation stored in the second memory device is set larger than the payout number of the winning symbol combination in the first correlation stored in the first memory device.
